(19) United States
(12) Patent Application Publication
(10) Pub. No.: US 2024/0426337 A1
(43) Pub. Date: Dec. 26, 2024

(54) SPHERICAL JOINT

(71) Applicants: Russell Jefferson Garehan, Marietta, GA (US); Todd Baker, Canton, GA (US)

(72) Inventors: Russell Jefferson Garehan, Marietta, GA (US); Todd Baker, Canton, GA (US)

(21) Appl. No.: 18/744,112

(22) Filed: Jun. 14, 2024

Related U.S. Application Data
(60) Provisional application No. 63/509,737, filed on Jun. 22, 2023.

(51) Int. Cl. F16C 11/06

(52) U.S. Cl. CPC F16C 11/0623

(57) ABSTRACT

Bearings are disclosed that include a housing, a race positioned within the housing, a ball positioned within the race, and a pin extending from the ball. The components may be configured such that the ball is fixed against translational movement relative to the race while the pin is extending from the ball and such that the race is fixed against translational movement relative to the housing while the ball is positioned within the race. Applications of these types of bearings in various fields including automotive components are also taught.

Spherical joints described herein may be used in a variety of ball and socket mechanical connections. Certain spherical joints disclosed herein may have utility in the automotive industry generally and in automotive shifters particularly. Spherical joints described herein may further be useful in a variety of other fields, particularly those having a need for durable and economical ball and socket mechanical connections. The bearings, more particularly, spherical joints described herein may be used as resilient and economical rod end bearings or Heim joints.

### BRIEF DESCRIPTION OF DRAWINGS

FIG. 1 depicts a rear view of a rocker including a spherical joint.

FIG. 2 depicts a side view of a rocker.

FIG. 3 depicts a front view of a rocker including a spherical joint.

FIG. 4 depicts an exploded view of a spherical joint in a rocker.

FIG. 5 depicts a cross-section view of a spherical joint in a rocker.

FIG. 6 depicts a cross-section view of a spherical joint in a rocker.

FIG. 7 depicts a cross-section view of a spherical joint in a rocker.

FIG. 8 depicts a view of a spherical joint in a rocker.

FIG. 9 depicts a rear view of a rod end.

FIG. 10 depicts a front view of a rod end.

FIG. 11 depicts a cross-section view of a rod end.

FIG. 12 depicts an exploded view of a rod end.

### DETAILED DESCRIPTION

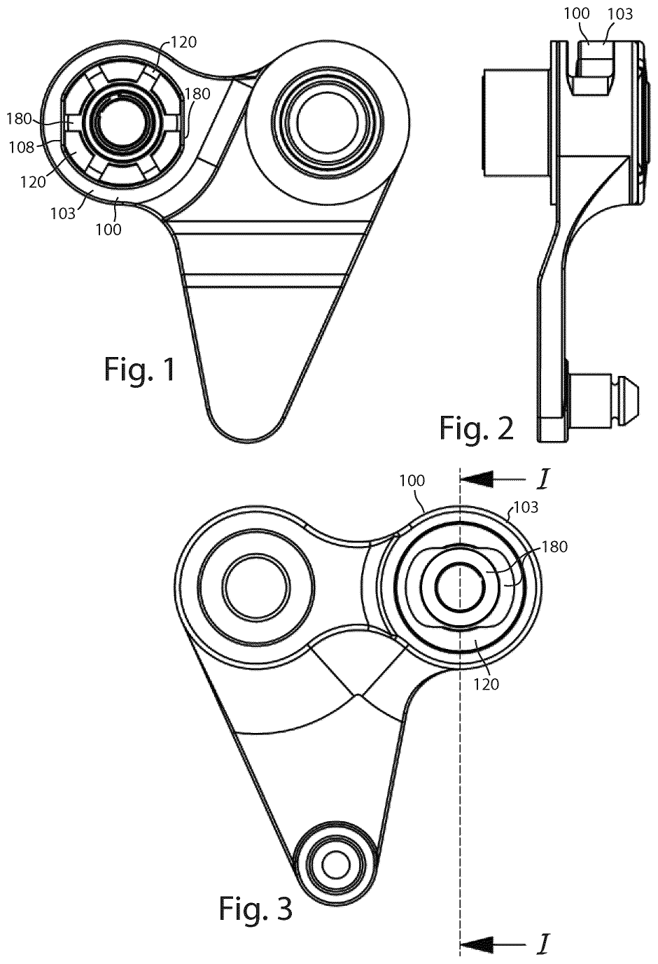

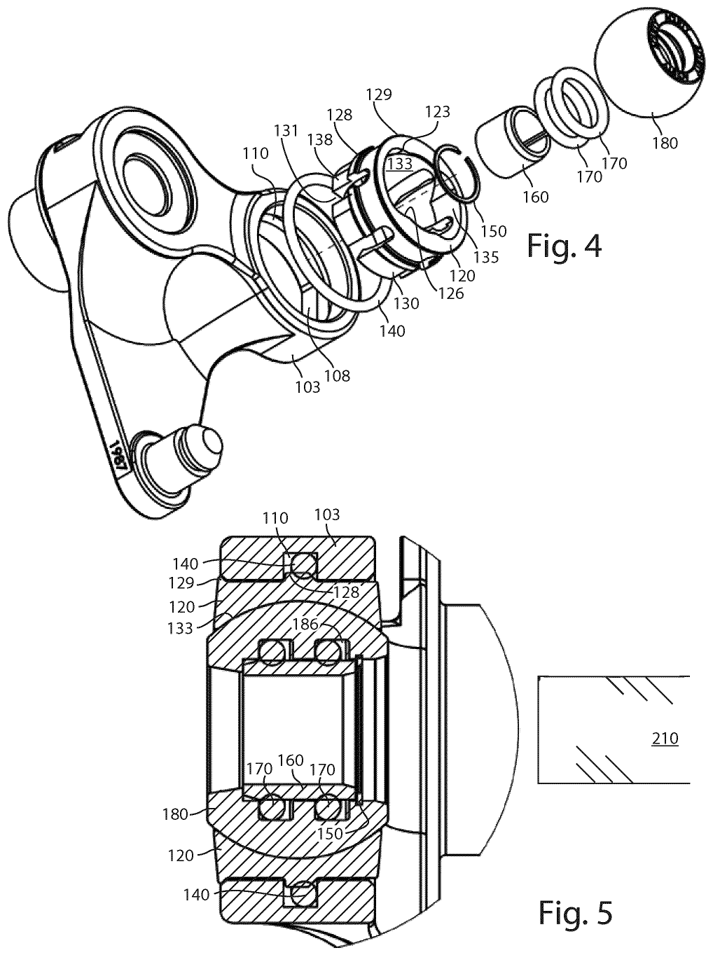

FIGS. 1-5 depict a wear-compensating spherical joint design with a spherical ball that has internal gap-compensating elastomeric bands, namely O-rings, and a gap-compensating sleeve, that may be plastic, for a gap-compensating effect with a pin that slides through the spherical ball. The depicted rocker is an automotive shifter rocker. The gap-compensating sleeve helps reduce friction as the pin slides axially within the gap-compensating sleeve within the spherical ball. Section line I in FIG. 3 indicates the direction of sight and location of the cross-section view of FIG. 5. Pin 210, which is not part of the cross-section, is included in FIG. 5 to show how the pin may slide within the ball. The components of FIG. 4 are exploded along explosion axis 90.

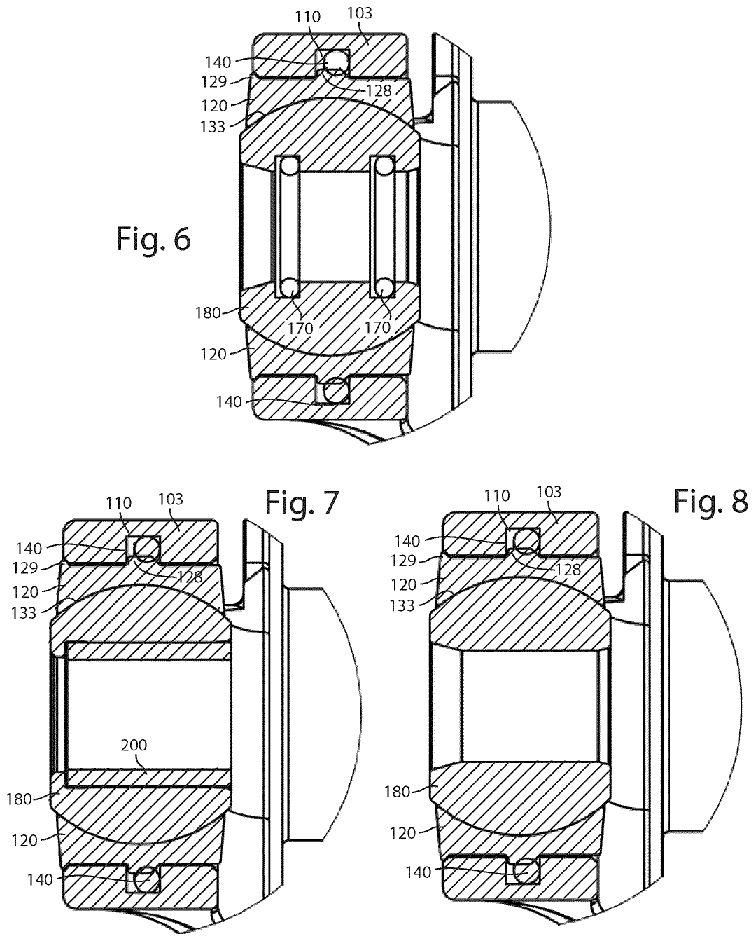

FIG. 6 depicts a wear-compensating spherical joint design with a spherical ball that has internal gap-compensating elastomeric bands. However, in this embodiment the gap-compensating elastomeric bands contact the pin that slides therethrough. Each of FIGS. 6, 7, and 8 are cross sections of different embodiments, but the cross-sectional view takes the same perspective as described in the presentation of FIG. 5.

FIG. 7 depicts a wear-compensating spherical joint design with a spherical ball that has a press-fit precision low friction bushing. This arrangement may create a low-clearance fit with the pin for the pin to slide through the spherical ball. Section line II in FIG. 10 shows the direction of sight and location of the cross-section view of FIG. 5.

FIG. 8 depicts a wear-compensating spherical joint design with a spherical ball that does not rely on additional internal features for gap-compensation or pin contact.

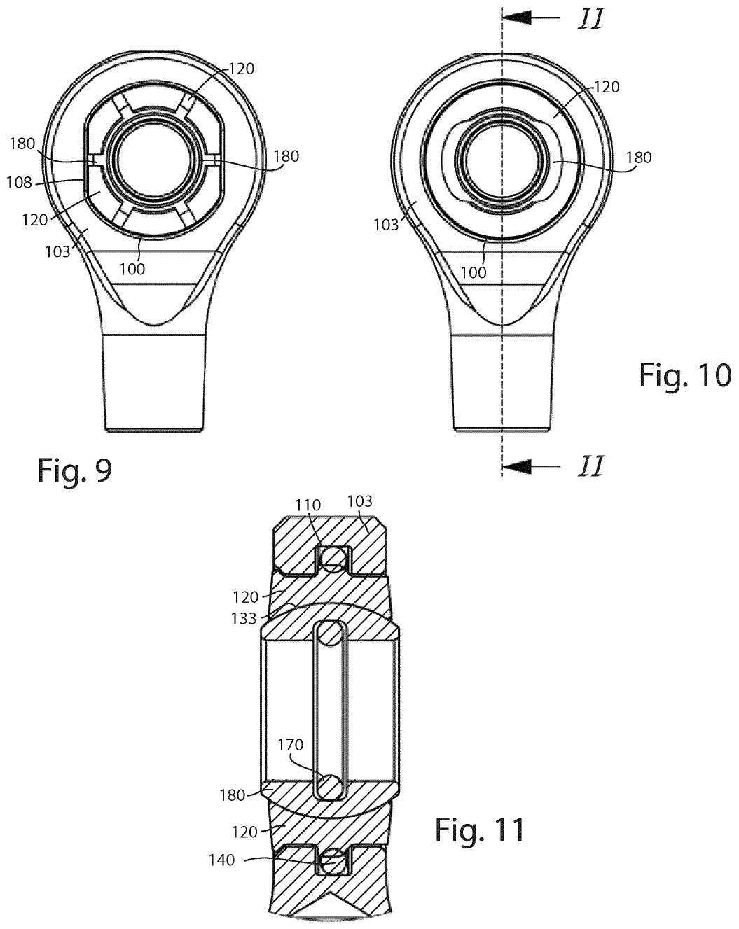

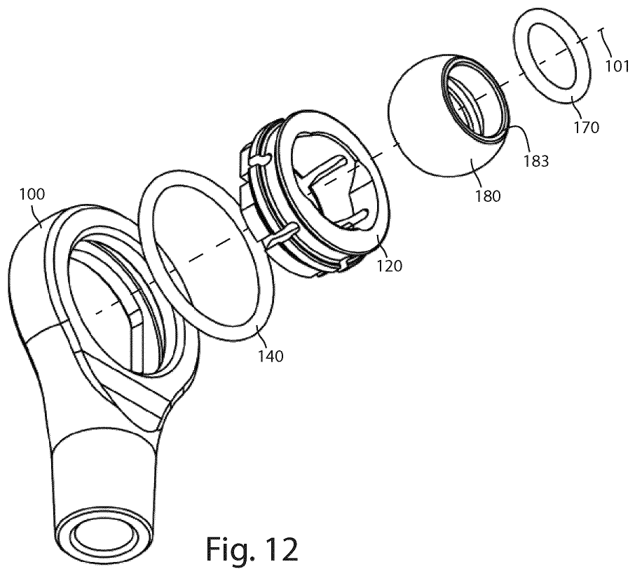

FIGS. 9-11 depict an alternate embodiment of the spherical joint appearing in a rod end. The rod end depicted in FIGS. 9-12 may for example be a rod end on an automotive shifter cable.

FIGS. 1-11 depict the following components:
bearing 100,
explosion axis 101,
housing 103,
housing race orientation surface 108,
housing elastomer channel 110,
race 120,
race ball orifice 123,
race ball orifice transit edges 126,
race center lip 128,
race edge lip 129,
race fingers 130,
race compression gaps 131,
race internal spherical surface 133,
race internal channel 135,
race orientation surface 138,
wear compensating elastomeric band 140,
retaining ring 150,
gap-compensating sleeve 160,
gap-compensating elastomeric band 170,
spherical ball 180,
spherical ball transit surface 183,
ball elastomer channels 186,
precision low friction bushing 200,
and pin 210.

The bearing may include a housing, a race, a wear compensating elastomeric band, and a spherical ball. The housing may be constructed to have a housing race orientation surface and a housing elastomer channel. The housing race orientation surface may be configured such that the race fits securely within the housing in a limited number of ways. As depicted in FIG. 4, there are two orientations in which the race could fit into the housing. Other configurations and geometries allowing the race to fit within the housing and resist rotation of the race within the housing upon final installation are contemplated. For example, a hexagonal collection of race orientation surfaces may serve as an equivalent securing mechanism. The housing elastomer channel may be configured to house or partially house the wear compensating elastomeric band during operation of the bearing.

The race may include race fingers configured to flex inward and outward relative to an axis of symmetry of the race. The race compression gaps between the fingers allow the flex necessary for the race fingers to operate and flex inward and outward. The race compression gaps may extend to greater than 50% of the height of the race and in many cases may extend to greater than 70% of the height of the race. The combined geometry of the race fingers, race compression gaps, and the race internal spherical surface allow for continued secure contact between the race and the spherical ball that may be maintained through a period of mechanical wear and that removes one, two, or three mils of material from either the spherical ball or the race. As used herein “mil” and “mils” refer to the US measurement describing thousandths of an inch. The continued secure contact between the race and the spherical ball may be maintained through longer periods of mechanical wear including wear resulting in the removal of ten or even thirty mils of material. Larger bearings used in contexts outside of those depicted may have still greater quantities of wear with continuous secure contact. Reference to an axis of symmetry of the race refers to the axis of greatest symmetry around which the race is constructed with the understanding that, as depicted, the race is not perfectly symmetrical around any axis. As described and depicted in FIG. 4, the race edge lip is symmetrical about the axis of symmetry of the race. The race edge lip may be configured to aid in positioning the race within the housing. The race center lip may have a variety of functions. The race center lip may act as the contact surface for the gap-compensating elastomeric band. That contact relationship may serve to urge the race fingers against the spherical ball during operation of the bearing. The race center lip may also act as a securing mechanism which fixes the race into the housing when the individual portions of race center lip snap into housing elastomer channel during installation. Further, the race center lip and the housing elastomer channel may act as part of a locking mechanism when the spherical ball is installed within the bearing because the spherical ball may limit the range of motion of the race center lip within the housing elastomer channel such that the presence of the spherical ball in the operating position disallows the race center lip from exiting the housing elastomer channel.

The race ball orifice may serve a variety of purposes. First, the race ball orifice has an opening that would disallow the spherical ball from entering the race when the spherical ball is in a relative orientation to the race comparable to the depiction of FIG. 4. From the relative orientation depicted in FIG. 4, rotating the spherical ball 90° such that the axis of symmetry of the spherical ball is perpendicular to the explosion axis and such that the spherical ball transit surface aligns with the race ball orifice transit edges the spherical ball may slide through the race ball orifice and down the race internal channel such that the spherical ball is received by the race. Upon doing so, the spherical surface of the spherical ball meets the race internal spherical surface. By rotating the spherical ball such that the axis of symmetry of the spherical ball again aligns with the explosion axis, the contact between the race internal spherical surface and the spherical surface of the spherical ball is maximized. Further the functional and ultimate operational relationship between the spherical ball and the race is established.

The wear compensating elastomeric band is installed in the housing elastomer channel before the race is inserted into the housing. The wear compensating elastomeric band is under continuous compression between the race center lip and the housing elastomer channel during operation of the bearing and supplies a continuous inward pressure on the race fingers by way of the pressure on the race center lip. This pressure coupled with the flexibility of the race fingers allows for a secure reliable operation of the bearing even after significant material has been removed by wear. In alternate embodiments, the wear compensating elastomeric band may operate under tension such that the tension in the elastomeric band operates to provide similar pressure on the race center lip. Multiple alternate mechanisms or materials may be used to create some form of encircling pressure operating at least in part from elastic deformation to hold the spherical ball in the race during operation.

A variety of bushing configurations may be used within the spherical ball. In one embodiment, gap-compensating elastomeric bands may be present between a gap-compensating sleeve and the spherical ball. In such embodiments a retaining ring may be used to secure the gap-compensating sleeve. The ball elastomer channels may exist within the spherical ball to retain the gap-compensating elastomeric bands. In such a case the pin may slide within the gap-compensating sleeve.

Other embodiments may rely directly on the gap-compensating elastomeric bands to position and guide the pin. In still other embodiments a precision friction bushing may be fit into the spherical ball. In still other embodiments, the internal surface of the ball may serve as the bushing.

Assembly of the bearing may proceed as follows. First, any internal components of the ball are installed within the ball. Second, the wear compensating elastomeric band is inserted into the housing such that it is retained by the housing elastomer channel. Third, the race is inserted into the housing such that the housing race orientation surface aligns with the race orientation surface and such that the race edge lip engages into the housing elastomer channel. Then, the spherical ball is oriented such that it may pass through the race ball orifice and into the race. Once the spherical ball is properly seated and in adequate contact with the race internal spherical surface the spherical ball is then rotated again exposing the opening in the spherical ball for insertion of the pin.

In various embodiments described herein, when the pin is inserted within an installed bearing the bearing may not be disassembled. This situation occurs because such disassembly requires rotation of the spherical ball to an extent that is not possible with an inserted pin. Disassembly during operation of the bearing is further prevented by the race center lip being locked into the housing elastomer channel. Specifically, the outer diameter of the spherical ball along with the configuration of the spherical ball transit surface may be mutually configured to lock the race within the housing when the spherical ball is in an operational orientation and to unlock the race from the housing when the spherical ball is in an installation orientation.

Although the depicted embodiments show a wear compensating elastomeric band that may be comparable to an O-ring and function as a rubber band, other materials having elastic properties may be used. For example, springs in various shapes and configurations may be used for similar effects.

The wear compensating elastomeric band allows the race to continuously hold the spherical ball with a constant or near constant level of grasping pressure that neither depends nor relies on manual adjustment.

The race, the spherical ball, and the gap-compensating sleeve may be constructed from a variety of resilient polymers including acetal polymers, polyoxymethylene polymers, nylons, high density polyethylene, and ultra-high molecular weight polyethylene. However, higher durability embodiments may include an anodized aluminum or a chromed steel spherical ball. When a metallic spherical ball is used, most of the wear between the race and the spherical ball occurs in the race. In many such cases, the material worn from the race exceeds the material worn from the spherical ball by a factor of 10 to 1 or greater. Elastomeric materials may be rubber including high durometer rubbers and grease compatible rubbers. The elastomeric materials may, for example, be a fluoroelastomer such as fluorine rubber namely fluorine Kautschuk material. Polymers and combinations that limit friction and degradation of the polymer may be selected depending on the intended service of the bearing.

Bearings described herein may be used in a variety of applications including automotive window regulators, automotive gear shifters, various other automotive mechanical linkages, aerospace spherical joints, and spherical joints linkages related to assembly or production lines. The joints described herein may be used in applications in which spherical joints compatible with wash downs are needed or desirable. These joints may further be used in consumer products, especially consumer products where lower unit costs for spherical joints are important.

Embodiments described herein allow installation without a mechanical press or other large tools. Because individual components may be assembled manually, end users or lower skill laborers may assemble these types of bearings. Further, these embodiments allow the production of joints having tight tolerances at lower cost and those joints may have low play in the joints. The play in the joint may be comparable to joints assembled by a mechanical press.

Multiple other bushing designs may be used internally to the spherical ball. Among those alternate designs are a bronze bushing within the spherical ball with no O-rings. Another alternative includes an internal sleeve of high-density polyethylene within the spherical ball supported by gap-compensating elastomeric bands.

In related embodiments the pin may attach to the spherical ball in a fixed relationship rather than a bushing type relationship. In such embodiments, the pin may attach to the ball by screwing into the ball, by way of a friction fit, or other means appropriate for the ultimate application in which the spherical joint is to be used.

The generation of pressure on the spherical ball during operation of the joint by the wear compensating elastomeric band is radial relative to the axis of symmetry of the race. That pressure also operates without any dependence on the application of axial force, any screw components, or any screwing motion. Further, the wear compensating force is applied by the wear compensating elastomeric band is distributed around the perimeter of the spherical ball rather than pinching or pinning the spherical ball. This configuration allows for a more evenly distributed wear pattern between the spherical ball and the race.

Bearings described herein may, for example, comprise a housing; a race positioned within the housing; a ball positioned within the race; and a pin extending from the ball; such that the ball is fixed against translational movement relative to the race while the pin is extending from the ball; and such that the race is fixed against translational movement relative to the housing while the ball is positioned within the race. In a related example, the ball and the housing are cooperatively arranged and configured such that the ball may be removed from the housing when the pin is not extending from the ball. In a related example, the ball and the race are cooperatively arranged and configured such that rotation of the ball to an installation orientation allows insertion of the ball into the race and removal of the ball from the race. In a related example, the housing, the race, and the ball are cooperatively arranged and configured such that the presence of the ball in an operational orientation within the race locks the race within the housing. In a related example, the housing, the race, and the ball are cooperatively arranged and configured such that removal of the race from the housing requires prior removal of the ball from the race.

Bearings described herein may, for example, comprise a housing; a race positioned within the housing; a ball positioned within the race; and a pin extending from the ball; such that the ball is fixed against translational movement relative to the race while the pin extends from the ball; such that the race exerts a radial force on the ball thereby retaining the ball; and such that an elastomeric component causes the radial force. In a related example, the ball and the housing are cooperatively arranged and configured such that the ball may be removed from the housing when the pin is not extending from the ball. In a related example, the ball and the race are cooperatively arranged and configured such that rotation of the ball to an installation orientation allows insertion of the ball into the race and removal of the ball from the race. In a related example, the radial force operates without any dependence on the application of an axial force. In a related example, the radial force is exerted through fingers on the race and the fingers are separated by gaps. In a related example, the radial force is distributed around the ball. In a related example, the elastomeric component is a ring contacting fingers on the race.

Bearings described herein may, for example, comprise a housing; a race positioned within the housing; a ball positioned within the race; and a pin extending from the ball; such that the race is fixed against translational movement relative to the housing while the ball is positioned within the race; such that the race exerts a radial force on the ball thereby retaining the ball; and such that an elastomeric component causes the radial force. In a related example, the housing, the race, and the ball are cooperatively arranged and configured such that the presence of the ball in an operational orientation within the race locks the race within the housing. In a related example, the housing, the race, and the ball are cooperatively arranged and configured such that removal of the race from the housing requires prior removal of the ball from the race. In a related example, the radial force operates without any dependence on the application of an axial force. In a related example, the radial force is exerted through fingers on the race and the fingers are separated by gaps. In a related example, the radial force is distributed around the ball. In a related example, the elastomeric component is a ring contacting fingers on the race. In a related example, the housing has an elastomer channel that contains the elastomeric component, the race comprises a lip which is in contact with the elastomeric component, and the lip is locked within the elastomer channel while the ball is positioned within the race.

The embodiments described herein have a number of independently useful individual features that have particular utility when used in combination with one another including combinations of features from embodiments described separately. There are, of course, other alternate embodiments which are obvious from the foregoing descriptions, which are intended to be included within the scope of the present application.

1. A bearing comprising:
a. a housing;
b. a race positioned within the housing;
c. a ball positioned within the race;
d. a pin extending from the ball;
e. wherein the ball is fixed against translational movement relative to the race while the pin is extending from the ball; and
f. wherein the race is fixed against translational movement relative to the housing while the ball is positioned within the race.

2. The bearing of claim 1, wherein the ball and the housing are cooperatively arranged and configured such that the ball may be removed from the housing when the pin is not extending from the ball.

3. The bearing of claim 1, wherein the ball and the race are cooperatively arranged and configured such that rotation of the ball to an installation orientation allows insertion of the ball into the race and removal of the ball from the race.

4. The bearing of claim 1, wherein the housing, the race, and the ball are cooperatively arranged and configured such that the presence of the ball in an operational orientation within the race locks the race within the housing.

5. The bearing of claim 1, wherein the housing, the race, and the ball are cooperatively arranged and configured such that removal of the race from the housing requires prior removal of the ball from the race.

6. A bearing comprising:
a. a housing;
b. a race positioned within the housing;
c. a ball positioned within the race;
d. a pin extending from the ball;
e. wherein the ball is fixed against translational movement relative to the race while the pin extends from the ball;
f. wherein the race exerts a radial force on the ball thereby retaining the ball; and
g. wherein an elastomeric component causes the radial force.

7. The bearing of claim 1, wherein the ball and the housing are cooperatively arranged and configured such that the ball may be removed from the housing when the pin is not extending from the ball.

8. The bearing of claim 1, wherein the ball and the race are cooperatively arranged and configured such that rotation of the ball to an installation orientation allows insertion of the ball into the race and removal of the ball from the race.

9. The bearing of claim 1, wherein the radial force operates without any dependence on the application of an axial force.

10. The bearing of claim 1, wherein the radial force is exerted through fingers on the race and wherein the fingers are separated by gaps.

11. The bearing of claim 1, wherein the radial force is distributed around the ball.

12. The bearing of claim 1, wherein the elastomeric component is a ring contacting fingers on the race.

13. A bearing comprising:
a. a housing;
b. a race positioned within the housing;
c. a ball positioned within the race;
d. a pin extending from the ball;
e. wherein the race is fixed against translational movement relative to the housing while the ball is positioned within the race;
f. wherein the race exerts a radial force on the ball thereby retaining the ball; and
g. wherein an elastomeric component causes the radial force.

14. The bearing of claim 1, wherein the housing, the race, and the ball are cooperatively arranged and configured such that the presence of the ball in an operational orientation within the race locks the race within the housing.

15. The bearing of claim 1, wherein the housing, the race, and the ball are cooperatively arranged and configured such that removal of the race from the housing requires prior removal of the ball from the race.

16. The bearing of claim 1, wherein the radial force operates without any dependence on the application of an axial force.

17. The bearing of claim 1, wherein the radial force is exerted through fingers on the race and wherein the fingers are separated by gaps.

18. The bearing of claim 1, wherein the radial force is distributed around the ball.

19. The bearing of claim 1, wherein the elastomeric component is a ring contacting fingers on the race.

20. The bearing of claim 1, wherein:
a. the housing has an elastomer channel that contains the elastomeric component,
b. the race comprises a lip which is in contact with the elastomeric component, and
c. the lip is locked within the elastomer channel while the ball is positioned within the race.
